(19) United States
(12) Patent Application Publication
(10) Pub. No.: US 2017/0308900 A1
(43) Pub. Date: Oct. 26, 2017

(54) SYSTEM AND METHOD FOR SCORING CROSS BORDER TRANSACTIONS

(71) Applicant: MasterCard International Incorporated, Purchase, NY (US)

(72) Inventor: Manoneet Kohli, O'Fallon, MO (US)

(21) Appl. No.: 15/134,043

(22) Filed: Apr. 20, 2016

(51) Int. Cl. G06Q 20/40; G06Q 20/38

(52) U.S. Cl. CPC G06Q 20/4016; G06Q 20/381

(57) ABSTRACT

A method includes receiving transaction data concerning a transaction. The transaction data includes at least one account holder category of information associated with the transaction. The transaction data includes at least one category of related transaction information associated with the transaction. The transaction data includes at least one category of merchant-related information associated with the transaction. The method further includes evaluating risk related to the transaction by analyzing information from (a) the at least one account holder category of information; (b) the at least one category of related transaction information; and (c) the at least one category of merchant-related information.

### BACKGROUND

Payment accounts are in widespread use for both in-store and online purchase transactions. FIG. 1 is a block diagram of a previously proposed version of a payment system (generally indicated by reference numeral 100) as it may operate in connection with an online purchase transaction.

The system 100 includes an e-commerce server computer 102 that may be operated by or on behalf of an online merchant to permit online shopping transactions. For this purpose, as is well known, the e-commerce server computer 102 may host a shopping website, sometimes referred to as an “online store”. A customer 103 who operates a customer device 104 may access the shopping website by communicating over the Internet 105 with the e-commerce server computer 102. As is very well-known to those who are skilled in the art, the customer device 104 may be, for example, a personal computer or notebook computer that runs a browser program, a tablet computer or smartphone that runs a mobile browser and/or a suitable app, etc. As is very familiar to those who shop online, after the customer has selected one or more items of merchandise for purchase from the online store, he/she may elect to enter a checkout phase of the online purchase transaction. In some situations, during the checkout phase, the customer enters payment information, such as a payment account number, expiration date, security code, etc. into an online form. However, according to some proposals, the customer may be presented with an option to select use of the customer's digital wallet, which has been stored in a wallet service provider's computer 106. The digital wallet may contain data relating to several of the customer's payment accounts, and selecting the digital wallet option may result in the customer being presented with the opportunity to select one of those payment accounts for use in the current online purchase transaction. Upon the customer indicating selection of one of the accounts in the digital wallet, the wallet service provider 106 may make the corresponding data (again, payment account number, expiration date, security code, etc.) for the selected account available to the merchant's e-commerce server 102.

In connection with the online purchase transaction, the e-commerce server computer 102 may transmit a transaction authorization request message (sometimes simply referred to as an “authorization request”) to the merchant's acquirer financial institution (“acquirer” or “transaction acquirer”), indicated by reference numeral 110. Assuming that the digital wallet scenario described above had occurred, the authorization request may include the payment data provided from the wallet service provider 106 to the e-commerce server 102.

The acquirer 110 may route the authorization request via a payment network 112 to a server computer 114 operated by the issuer of the payment account that corresponds to the payment data included in the authorization request. Also, the authorization response generated by the issuer server computer 114 may be routed back to the acquirer 110 via the payment network 112. The acquirer 110 may confirm to the merchant (i.e., to the e-commerce server computer 102) that the transaction has been approved.

The payment network 112 may be, for example, the well-known Banknet® system operated by MasterCard International Incorporated, which is the assignee hereof

The components of the system 100 as depicted in FIG. 1 are only those that are needed for processing a single transaction. Those who are skilled in the art will recognize that in the real world, online shopping and payment systems may process many purchase transactions (including simultaneous transactions) and may include a considerable number of payment account issuers and their computers, a considerable number of acquirers and their computers, and numerous merchants and their e-commerce servers. The system may also include a very large number of customers/online shoppers, who hold payment accounts that they use for their online shopping activities. In some environments there may also be a number of wallet service providers. It is also well known that elements of the system 100 (e.g., acquirers, the payment network, payment account issuers) may play similar roles in connection with in-store purchase transactions and in other types of transactions.

The present inventor has recognized opportunities to improve evaluation of risk in regard to “cross border” payment account system transactions. As used in this document, the term “cross border” refers to a payment account transaction in which the merchant is located in a different country from the country in which the payment account was issued.

### BRIEF DESCRIPTION OF THE DRAWINGS

Features and advantages of some embodiments of the present disclosure, and the manner in which the same are accomplished, will become more readily apparent upon consideration of the following detailed description of the disclosure taken in conjunction with the accompanying drawings, which illustrate preferred and exemplary embodiments and which are not necessarily drawn to scale, wherein:

FIG. 1 is a block diagram that illustrates a conventional system that handles online purchase transactions.

FIG. 2 is a block diagram of a payment system according to some embodiments.

FIGS. 3 and 4 are block diagram representations of computers that may serve as components of the system shown in FIG. 2.

FIG. 5 is a flow chart that illustrates aspects of the present disclosure.

### DETAILED DESCRIPTION

In general, and for the purpose of introducing concepts of embodiments of the present disclosure, several categories of information are analyzed in performing risk scoring in connection with a cross border payment account transaction. Some of the information categories may relate to the holder of the payment account to be used in the transaction. Others of the information categories may be concerned with transactions that may be viewed as related to the transaction that is being evaluated. Still other information categories may be related to the merchant that is involved in the transaction. Results of the analysis of these categories of information may be subject to weighting to produce a risk score. The risk score may be compared to a threshold value to determine whether to approve or decline a transaction.

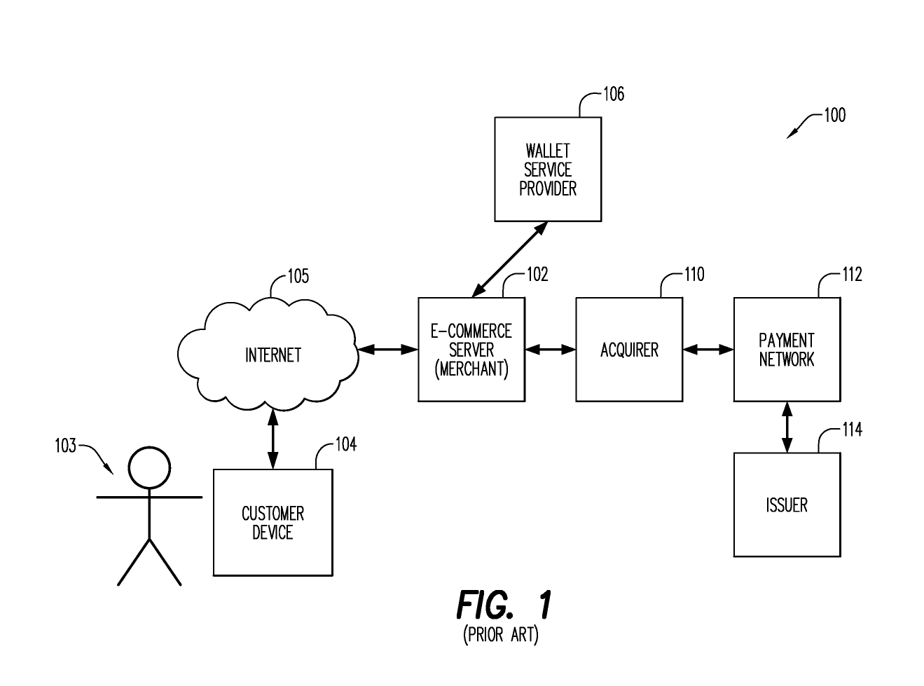

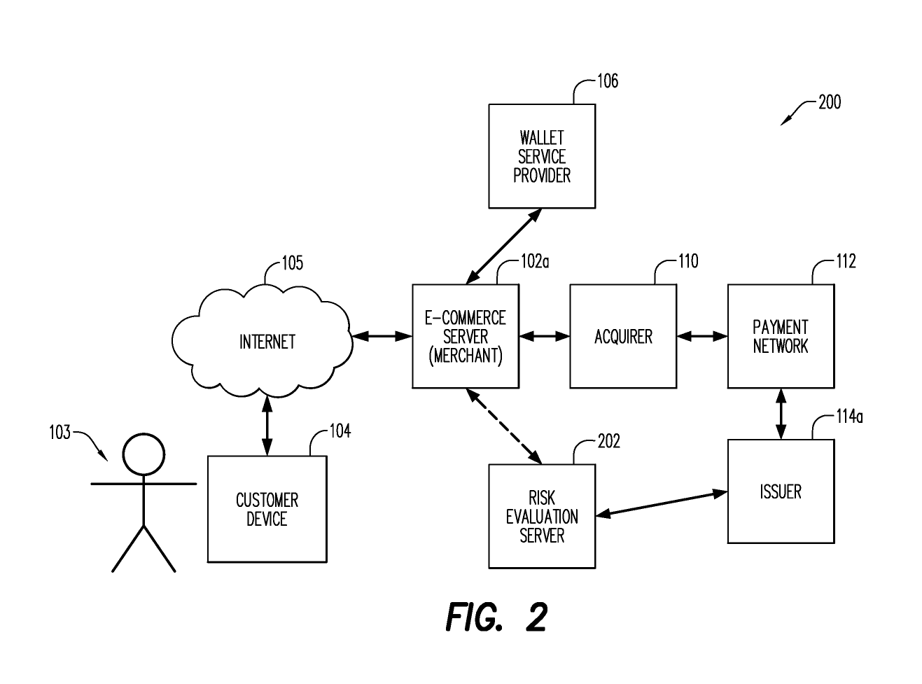

FIG. 2 is a block diagram of a payment system 200 provided according to some embodiments. The payment system 200 incorporates all of the elements referred to above in connection with FIG. 1. For example, elements/entities 103, 104, 105, 106, 110 and 112 are carried over in the payment system 200 as depicted in FIG. 2 from the depiction of the payment system 100 shown in FIG. 1. Further, an element 102a shown in FIG. 2 represents an e-commerce server (merchant) that may differ in a relatively few respects from the conventional e-commerce server 102a shown in FIG. 1. An element 114a shown in FIG. 2 represents an issuer server computer that may differ in a relatively few respects from the conventional issuer server computer 114 shown in FIG. 1.

According to aspects of the present disclosure, the payment system 200 also includes a risk evaluation server 202. Details of the risk evaluation server 202 will be discussed below. To briefly summarize some of the functionality of the risk evaluation server 202, it may respond to requests from the issuer server computer 114a and/or from the e-commerce server 102a to perform risk evaluation with respect to cross border payment account transactions. The risk evaluation may be based on a number of categories of information as described in detail below.

In some embodiments, the risk evaluation server 202 may be under common operation with the payment network 112.

To discuss the subject matter of FIG. 2 more generally, it should be understood that in most cases, blocks labeled therein with names/descriptions of entities should also be understood to represent computer systems operated by or for such entities.

It should also be understood that, for at least some types of participants in the payment system 200, there may be a considerable or even a very large number of participants of those types in practical embodiments of the payment system 200. Moreover, one or more components of the payment system 200 may handle in-store purchase transactions and/or other types of transactions in addition to online purchase transactions.

In a typical situation that is of particular interest in connection with this disclosure, it is assumed that the user 103 and the customer device 104 are located in a different country from the e-commerce server 102a (or a different country from the merchant for which the e-commerce server is operated) and/or that the payment account proposed to be used for the transaction is issued in a different country from the location of the merchant/e-commerce server.

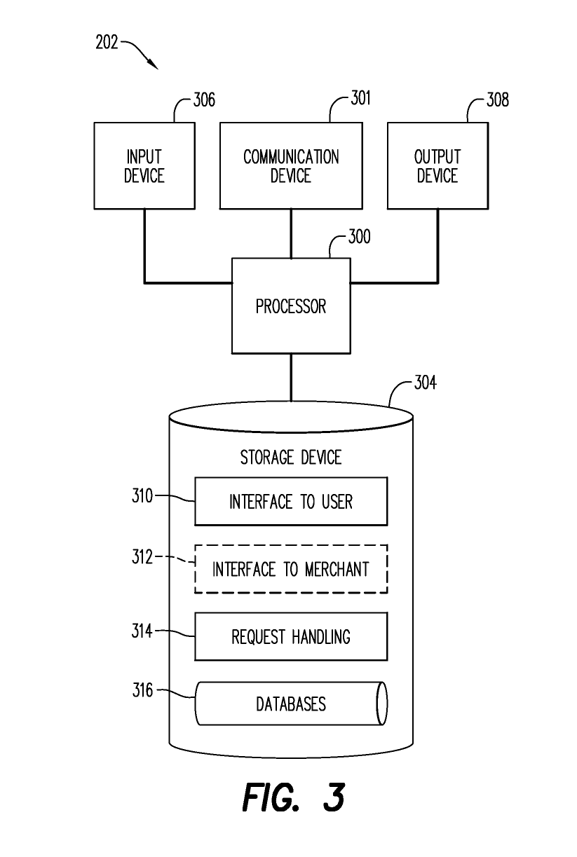

FIG. 3 is a block diagram representation of an embodiment of the risk evaluation server 202.

In some embodiments, hardware aspects of the risk evaluation server 202 may be constituted by typical server computer hardware, but may be controlled by software to cause it to function as described herein.

The risk evaluation server 202 may include a processor 300 operatively coupled to a communication device 301, a storage device 304, an input device 306 and an output device 308. The communication device 301, the storage device 304, the input device 306 and the output device 308 may all be in communication with the processor 300.

The processor 300 may be constituted by one or more processors. The processor 300 may operate to execute processor-executable steps, contained in program instructions described below, so as to control the risk evaluation server 202 to provide desired functionality.

Communication device 301 may be used to facilitate communication with, for example, other devices (such as e-commerce servers and/or issuer server computers). For example, communication device 301 may comprise numerous communication ports (not separately shown), to allow the risk evaluation server 202 to respond simultaneously to numerous requests for transaction risk evaluation.

Input device 306 may comprise one or more of any type of peripheral device typically used to input data into a computer. For example, the input device 306 may include a keyboard and a mouse. Output device 308 may comprise, for example, a display and/or a printer.

Storage device 304 may comprise any appropriate information storage device, including combinations of magnetic storage devices (e.g., hard disk drives), optical storage devices such as CDs and/or DVDs, and/or semiconductor memory devices such as Random Access Memory (RAM) devices and Read Only Memory (ROM) devices, as well as so-called flash memory. Any one or more of such information storage devices may be considered to be a computer-readable storage medium or a computer usable medium or a memory.

Storage device 304 stores one or more programs for controlling processor 300. The programs comprise program instructions (which may be referred to as computer readable program code means) that contain processor-executable process steps of the risk evaluation server 202, executed by the processor 300 to cause the risk evaluation server 202 to function as described herein.

The programs may include one or more conventional operating systems (not shown) that control the processor 300 so as to manage and coordinate activities and sharing of resources in the risk evaluation server 202, and to serve as a host for application programs (described below) that run on the risk evaluation server 202.

The programs stored in the storage device 304 may also include a software interface 310 that controls the processor 300 to support communication between the risk evaluation server 202 and issuer server computers such as the computer represented by block 114a in FIG. 2.

The storage device 304 may also store a software interface 312 that controls the processor 300 to support communication between the risk evaluation server 202 and e-commerce servers such as the computer represented by block 102a in FIG. 2.

Further, the storage device 304 may store a risk evaluation request handling application program 314. The risk evaluation request handling application program 314 may control the processor 300 such that the risk evaluation server 202 provides functionality as described herein in connection with requests to evaluate risk with respect to payment account transactions.

The storage device 304 may also store, and the risk evaluation server 202 may also execute, other programs, which are not shown. For example, such programs may include a reporting application, which may respond to requests from system administrators for reports on the activities performed by the risk evaluation server 202. The other programs may also include, e.g., device drivers, database management programs, communications software, etc.

In some embodiments, the storage device 304 may also store one or more databases (reference numeral 316) required for operation of the authentication system 202.

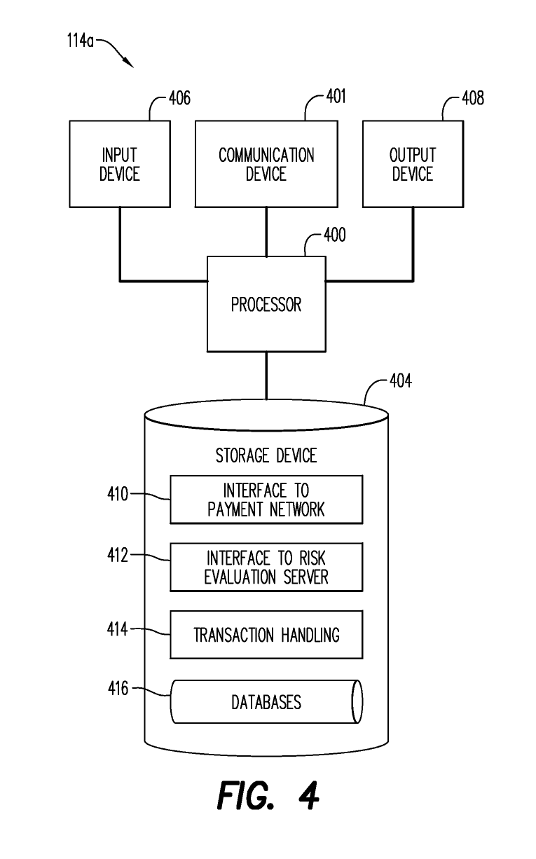

FIG. 4 is a block diagram of an embodiment of the issuer server computer 114a.

In its hardware architecture and components, the issuer server computer 114a may, for example, resemble the hardware architecture and components described above in connection with FIG. 3. However, the issuer server computer 114a may be programmed differently from the risk evaluation server 202 so as to provide different functionality.

Returning again to the hardware aspects of the issuer server computer 114a, it may include a processor 400, a communication device 401, a storage device 404, an input device 406 and an output device 408. The communication device 401, the storage device 404, the input device 406 and the output device 408 may all be in communication with the processor 400.

The above descriptions of the hardware components shown in FIG. 3 may, in some embodiments, also be applicable to the like-named components shown in FIG. 4.

Storage device 404 stores one or more programs for controlling processor 400. The programs comprise program instructions (which may be referred to as computer readable program code means) that contain processor-executable process steps of the issuer server computer 114a, executed by the processor 400 to cause the issuer server computer 114a to function as described herein.

The programs may include one or more conventional operating systems (not shown) that control the processor 400 so as to manage and coordinate activities and sharing of resources in the issuer server computer 114a, and to serve as a host for application programs (described below) that run on the issuer server computer 114a.

The programs stored in the storage device 404 may include a software interface 410 that controls the processor 400 to support interactions between the issuer server computer 114a and the payment network 112 (FIG. 2).

Continuing to refer to FIG. 4, the storage device 404 may also include a software interface 412 to support interactions between the issuer server computer 114a and the risk evaluation server 202.

Further, the storage device 404 may store a transaction handling program 414 that controls the processor 400 so as to enable the issuer server computer 114a to handle payment account transactions relating to payment accounts issued by the financial institution that operates the issuer server computer 114a. To a considerable extent, the functionality provided by the transaction handling program 414 may mirror functions present in the conventional issuer server computer 114 shown in FIG. 1. In addition, the transaction handling program 414 may support additional functionality to facilitate risk evaluation for cross border payment account transactions in accordance with aspects of the present disclosure.

The storage device 404 may also store, and the issuer server computer 114a may also execute, other programs, which are not shown. For example, such programs may include a reporting application, which may respond to requests from system administrators for reports on the activities performed by the issuer server computer 114a. The other programs may also include, e.g., device drivers, database management programs, communication software, etc.

The storage device 404 may also store one or more databases (reference numeral 416) required for operation of the issuer server computer 114a.

Other computer components of the payment system 200 (FIG. 2) may also have the same type of hardware architecture and/or components as described above in connection with FIG. 3, and may be suitably programmed for the respective roles of those computer components. For example, the e-commerce server 102a may be programmed to perform functions normally present in a conventional e-commerce server, while also being programmed to facilitate evaluation of risk for cross border payment account transactions according to aspects of the present disclosure.

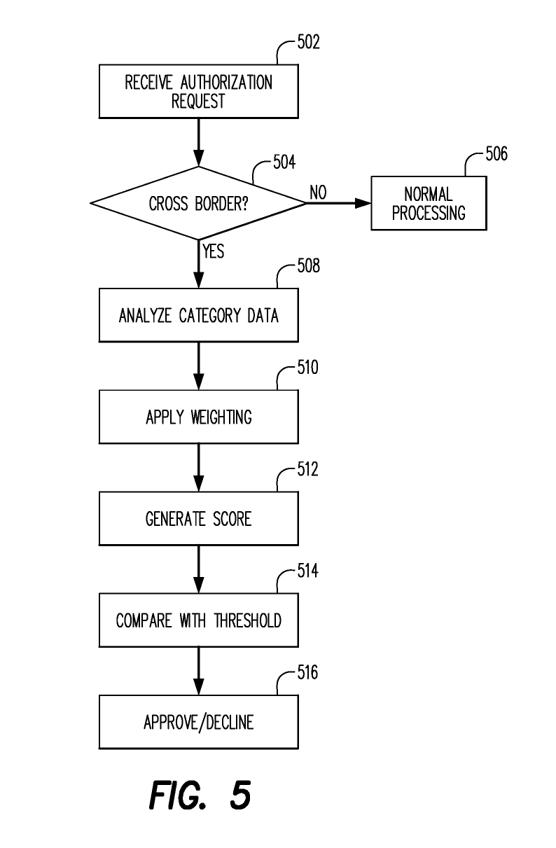

FIG. 5 is a flow chart that illustrates a process that may be performed in the system 200 in accordance with aspects of the present disclosure.

At block 502, the issuer server computer 114a may receive a transaction authorization request message for a proposed payment account transaction.

Decision block 504 may follow block 502. At decision block 504, the issuer server computer 114a may determine whether the requested transaction is a cross border transaction. This determination may, for example, be based on the location of the merchant, as indicated in the authorization request message, and also based on the country in which the issuer issued the payment account pointed to by the payment account number included in the transaction authorization request.

If a negative determination is made at decision block 504 (i.e., if the issuer server computer 114a determines that the requested transaction is not a cross border transaction), then block 506 may follow decision block 504. At block 506, the issuer server computer 114a may process the transaction authorization request in a typical manner for handling domestic transactions.

Referring again to decision block 504, if a positive determination is made at that decision block (i.e., if the issuer server computer 114a determines that the requested transaction is a cross border transaction), then the issuer server computer 114a may send a request to the risk evaluation server 202 to perform a risk evaluation with respect to the transaction in accordance with aspects of the present disclosure as described below. This may lead to a series of process steps including a step 508 which is discussed below. This series of process steps may occur in response to the risk evaluation server 202 receiving the request from the issuer server computer 114a. The request from the issuer server computer 114a to the risk evaluation server 202 may include or make available to the risk evaluation server 202 a number of categories of information related to the current transaction. In accordance with aspects of the present disclosure, the categories of information received by and/or made available to the risk evaluation server 202 for analysis at block 508 may include (1) account holder categories of information; (2) related transaction information; and (3) merchant-related information.

As used herein and in the appended claims, “account holder categories of information” refers to any one or more of: (a) one or more account characteristics indicated by a BIN (bank identification number) portion of the payment account number included in the authorization request; (b) the date of issuance of the payment account to be used for the requested transaction; (c) a country of origin for the transaction (e.g., the country in which the payment account was issued) and/or whether the transaction originates from a digital wallet; and (d) a count of transactions recently performed using the payment account in question with merchants in the same merchant category as the merchant involved in the current transaction.

As used herein and in the appended claims, “related transaction information” refers to one or more of: (a) a count of previous and successful cross border payment account transactions performed by the account holder (and/or by using the payment account to be used for the present transaction) over a pre-determined period of time (e.g., several months or a few years) prior to the current point in time; (b) a count of previous and successful transactions of all kinds performed by the account holder (and/or using the payment account to be used for the present transaction) over a pre-determined period of time (e.g., one week) prior to the current point in time; (c) a count of previous and successful transactions performed by the account holder (and/or by using the payment account to be used for the present transaction) in a similar monetary amount/price range to the current transaction over a pre-determined period of time (e.g., several months) prior to the current point in time; and (d) a count of abandoned transactions recorded for the payment account to be used for the present transaction over a pre-determined period of time (e.g., several weeks) prior to the current point in time.

As used herein and in the appended claims, “merchant-related information” refers to one or more of: (a) the geographic distance between the country of issuance of the payment account to be used for the present transaction and the country where the merchant is located; (b) an indication as to whether the merchant offers free shipping on e-commerce transactions; and (c) a count of cross border transactions recorded involving the current merchant and the country of issuance of the payment account to be used for the current transaction over a pre-determined period of time (e.g., a few months) prior to the current point in time.

An example embodiment of the analysis that may be performed at block 508 will now be described. More detail will also be provided of examples of categories of information that may be made available for analysis by the risk evaluation server 202.

Commencing with categories of account holder information, the information available for analysis may include the above-mentioned BIN. As is well known to those who are skilled in the art, the BIN is typically the first six digits of the payment account number. In some embodiments, the BIN may be examined with respect to two possible characteristics that it may have. The first characteristic is an indication that the BIN comes from a BIN range that is reserved for corporate card accounts and/or VCNs (virtual card numbers)—on the one hand—or on the other hand is from a BIN range that is reserved for ordinary account number. If the BIN is found to have the former characteristic (corporate or VCN) it may be regarded as more trustworthy and may be scored “1”; if the BIN is indicative of an ordinary account number, it may be regarded as less trustworthy and may be scored “0”.

A second characteristic of the BIN that may be examined is as to whether it comes from a BIN range reserved for elite card account products, such as those typically available only to account holders who have a high net worth (HNW) or who have a high degree of public prominence. If the BIN is found to come from a BIN range reserved for elite card account products, then an additional score of “1” (highly trustworthy) may be added; otherwise a score of “0” is applied.

Another category of account holder information that may be available is the date on which the issuer issued the payment account to be used for the present transaction. In other words, the age of the account (i.e., time elapsed since the account was issued) may be examined. For example, the risk evaluation server 202 may examine whether the account was issued at least 6 months prior to the current time. If so, then it may be deemed relatively trustworthy and a score of “1” may be applied for this category of information. If the account is relatively new (in this example, issued less than 6 months before), then the score is “0”. It should be noted that a “newness” cut-off threshold of other than 6 months may be used in some embodiments, and/or in some situations. For example, a cut-off of 2 months may alternatively be used. In some embodiments, the cut-off time period may be determined according to the preference of the issuer that sent the request to the risk evaluation server 202. The issuer may, for example, inform the risk evaluation server 202, in advance, of the length of the “newness” cut-off period to be applied to all requests sent from the issuer to the risk evaluation server 202. “Newness” cut-off periods of different lengths may be applied for requests from different issuers.

Still another account holder category of information may relate to “origination” of the transaction. This type of information may take one or more of a number of different forms. For example, the available data may indicate whether or not a digital wallet was involved in initiating the transaction. If so, then this may indicate a greater degree of trustworthiness and lead to a score of “1” for this category of information. Otherwise, the score may be “0” for this category of information. In addition or alternatively, the account holder's home country (e.g., the country in which the payment account was issued) may be an available piece of information. For some countries, regarded as high risk (e.g., Eastern Europe, some countries in South America), the score may be “0”; for countries not regarded as high risk the score may be “1”.

According to yet another category of account holder information, the available information may include a count (over a pre-determined period of time prior to the present time) of other transactions made with the payment account in question with merchants in the same category as the merchant involved in the current transaction. In examining this item of information, the risk evaluation server 202 may compare the count of such prior transactions with a threshold number. If the count reaches or exceeds the threshold number, then this may be taken as an indication of greater trustworthiness, leading to a score of “1” for this category of information; otherwise, the score would be “0”.

To complete the analysis of the account holder categories of information, the risk evaluation server 202 may sum the “1” scores (if any) attributable to each of the categories enumerated above, leading to an overall score for that group of categories in the range of (perhaps) 5 or 6 to zero.

Analysis of the related-transaction categories of information will now be described.

A first category of related-transaction information may be a count of previous and successful cross border transactions engaged in with the payment account in question over a pre-determined period of time prior to the present time. If the count reaches or exceeds a threshold number, then this may be considered an indication of greater trustworthiness, leading to a score of “1” for this category of information; otherwise, the score would be “0”.

A second category of related-transaction information may be a count of successful transactions (whether or not cross border) engaged in with the payment account in question over a pre-determined period of time prior to the present time. If the count reaches or exceeds a threshold number, then this may indicate greater trustworthiness, leading to a score of “1” for this category of information; otherwise the score would be “0”.

A third category of related transaction information may be a count of transactions engaged in with the payment account in question in a similar price range to the amount to be charged in the present transaction over a pre-determined period of time prior to the present time. (To aid in this analysis, a set of categories of transaction amounts may be defined—e.g., less than $50=low; $50 to $250=moderate; $250 to $1,000=high; over $1,000=very high.) If the count reaches or exceeds a threshold number, then this may indicate greater trustworthiness, leading to a score of “1” for this category of information; otherwise the score would be “0”. (Other sets of price ranges may be employed in other embodiments or in other situations (e.g., depending on client preferences).)

A fourth category of related transaction information may be a count of transactions commenced but not completed (i.e., abandoned) using the payment account in question over a pre-determined period of time prior to the present time. (An “abandoned” transaction may occur, for example, when the user is presented with a user authentication challenge and fails to respond successfully to the challenge.) If the count reaches or exceeds a threshold number, then this may indicate a lack of trustworthiness, leading to a score of “0” for this category of information; otherwise the score would be “1”.

To complete the analysis of the related-transaction categories of information, the risk evaluation server 202 may sum the “1” scores (if any) attributable to each of the related-transaction categories enumerated above, leading to an overall score for that group of categories in the range of (perhaps) 4 to zero.

Analysis of the merchant-related categories of information will now be described.

A first category of merchant-related information may be the geographic distance between the country of the account holder and/or issuer and the country of the merchant. If this distance is greater than a threshold value (say 500 miles), then this may indicate a lack of trustworthiness, leading to a score of “0” for this category of information; otherwise the score would be “1”.

A second category of merchant-related information may be an indication as to whether the merchant offers free shipping on orders. If the indication is “yes”, then this may indicate greater trustworthiness (a greater likelihood of legitimate cross border transactions), leading to a score of “1” for this category of information; otherwise the score would be “0”.

A third category of merchant-related information may be a count of cross border transactions involving both the current merchant and the country of the account holder/issuer over a pre-determined period of time prior to the present time. If the count reaches or exceeds a threshold number, then this may indicate greater trustworthiness (indicating a pattern of legitimate transactions of customers in the issuer's country with the merchant in question), leading to a score of “1” for this category of information; otherwise the score would be “0”.

To complete the analysis of the related-transaction categories of information, the risk evaluation server 202 may sum the “1” scores (if any) attributable to each of the related-transaction categories enumerated above, leading to an overall score for that group of categories in the range of (perhaps) 3 to zero.

As indicated by block 510 in FIG. 5, the risk evaluation server 202 may then apply weighting factors to each of the group scores generated by the analysis of the information for the account holder, related-transaction, and merchant-related category groups. For example, the factor applied to the group score of the account holder category group may be 0.40; the factor applied to the group score of the related-transaction category group may be 0.30; and the factor applied to the group score of the merchant-related category group may be 0.30.

Then, at block 512, the weighted group scores may be summed to produce an overall risk score for the transaction. (It will be appreciated that with the process as described above, a higher score is indicative of less risk.)

In an example set forth above, a score of “1” or “0” is assigned with respect to each category of information when scoring the current transactions. However, in other embodiments, there may be other scoring schemes, such as scoring anywhere in a range bounded by one and zero. In some embodiments, the types/range of scores applied may vary according to the previously registered preferences of the client (issuer or merchant) that requested the risk evaluation. Also, the attribution of high or low risk to certain input information items may vary from embodiment to embodiment and/or according to client preference. For example, referring to one above-mentioned aspect of examining the BIN range of the relevant payment account, instead of considering a corporate account BIN range to imply a low level of risk and an ordinary BIN range to imply a high level of risk, those attributions of risk may be reversed in some embodiments and/or for some clients.

At block 514, the risk evaluation server 202 may compare the risk score generated at 512 with a risk score threshold. (Or alternatively, this action may occur at the issuer, in response to receiving the risk score from the risk evaluation server 202.) At 516, the transaction may be approved or declined depending on whether the risk score exceeds or does not exceed the risk score threshold. This step too may occur either at the risk evaluation server 202 or at the issuer.

In some embodiments, any one or more of the thresholds referred to above may be set as prescribed by the issuer's preferences in terms of appetite for risk, sensitivity to various kinds of risk, etc. In general, the different thresholds may vary from each other, but some may be the same. For example, only one “related” transaction of a given kind, in some situations or for some categories, may be deemed to imply trustworthiness.

While the above description has generally featured the issuer as the client for services provided by the risk evaluation server 202, in other embodiments the client may at least sometimes be the merchant.

An array of various types of information categories has been described in an example embodiment above. In other embodiments, however, any one or more of the information categories may be dropped out, and/or one or more different information categories or even groups of information categories may be added instead and/or in addition.

It should also be understood that the category group weighting values referred to above are only one example of many possible sets of weighting values. Moreover, the weighting values to be applied may vary from client to client depending on the client's preferences.

A risk evaluation process provided in accordance with processes as described herein may improve decision-making as to approval or declining of cross-border payment account transactions, and may allow the risks potentially involved in such transactions to be evaluated in an effective manner.

While a focus of the above discussion has been on cross border payment account transactions, at least some elements of the teachings herein may also be applicable to other categories of payment account transactions.

As used herein and in the appended claims, the term “computer” should be understood to encompass a single computer or two or more computers in communication with each other.

As used herein and in the appended claims, the term “processor” should be understood to encompass a single processor or two or more processors in communication with each other.

As used herein and in the appended claims, the term “memory” should be understood to encompass a single memory or storage device or two or more memories or storage devices.

As used herein and in the appended claims, a “server” includes a computer device or system that responds to numerous requests for service from other devices.

The flow charts and descriptions thereof herein should not be understood to prescribe a fixed order of performing the method steps described therein. Rather the method steps may be performed in any order that is practicable, including simultaneous performance of steps.

As used herein and in the appended claims, the term “payment card system account” includes a credit card account, a deposit account that the account holder may access using a debit card, a prepaid card account, or any other type of account from which payment transactions may be consummated. The terms “payment card system account” and “payment card account” and “payment account” are used interchangeably herein. The term “payment card account number” includes a number that identifies a payment card system account or a number carried by a payment card, or a number that is used to route a transaction in a payment system that handles debit card and/or credit card transactions. The term “payment card” includes a credit card, debit card, prepaid card, or other type of payment instrument, whether an actual physical card or virtual.

As used herein and in the appended claims, the term “payment card system” refers to a system for handling purchase transactions and related transactions. An example of such a system is the one operated by MasterCard International Incorporated, the assignee of the present disclosure. In some embodiments, the term “payment card system” may be limited to systems in which member financial institutions issue payment card accounts to individuals, businesses and/or other organizations.

Although the present disclosure has been described in connection with specific exemplary embodiments, it should be understood that various changes, substitutions, and alterations apparent to those skilled in the art can be made to the disclosed embodiments without departing from the spirit and scope of the disclosure as set forth in the appended claims.

What is claimed is:

1. A method comprising:
receiving transaction data concerning a transaction; the transaction data including at least one account holder category of information associated with the transaction; the transaction data including at least one category of related transaction information associated with the transaction; the transaction data including at least one category of merchant-related information associated with the transaction; and
evaluating risk related to the transaction by analyzing information from (a) said at least one account holder category of information; (b) said at least one category of related transaction information; and (c) said at least one category of merchant-related information.

2. The method of claim 1, wherein the analyzing of said at least one account holder category of information includes examining at least one characteristic of a BIN (bank identification number) included in an account number that points to a payment account to which the transaction is to be charged.

3. The method of claim 2, wherein the analyzing of said at least one account holder category of information includes examining two characteristics of a BIN (bank identification number) included in an account number that points to a payment account to which the transaction is to be charged.

4. The method of claim 1, wherein the analyzing of said at least one account holder category of information includes examining an age of a payment account to which the transaction is to be charged.

5. The method of claim 1, wherein the transaction is with a merchant located in a first country and is to be charged to a payment account issued in a second country different from the first country.

6. The method of claim 1, wherein the analyzing of said at least one account holder category of information includes examining a country of domicile of a payment account to which the transaction is to be charged.

7. The method of claim 1, wherein the analyzing of said at least one account holder category of information includes examining a history of transactions associated with a payment account to which the transaction is to be charged.

8. The method of claim 1, wherein said at least one category of related transaction information includes a count of successful payment account transactions performed during a pre-determined period of time with a payment account to which the transaction is to be charged.

9. The method of claim 1, wherein said at least one category of merchant-related information includes a distance between a first location and a second location, the first location associated with a merchant involved in the transaction, the second location being a home address of an account holder involved in the transaction.

10. The method of claim 1, wherein said at least one category of merchant-related information includes an indication as to whether free shipping is offered by a merchant involved in the transaction.

11. The method of claim 1, wherein said at least one category of related transaction information includes a count of successful payment account transactions performed within a pre-defined price range category during a pre-determined period of time with a payment account to which the transaction is to be charged, said pre-defined price range category corresponding to a price range category of the transaction for which transaction data was received in the receiving step.

12. An apparatus comprising:
a processor; and
a memory in communication with the processor, the memory storing program instructions, the processor operative with the program instructions to perform functions as follows:
receiving transaction data concerning a transaction; the transaction data including at least one account holder category of information associated with the transaction; the transaction data including at least one category of related transaction information associated with the transaction; the transaction data including at least one category of merchant-related information associated with the transaction; and
evaluating risk related to the transaction by analyzing information from (a) said at least one account holder category of information; (b) said at least one category of related transaction information; and (c) said at least one category of merchant-related information.

13. The apparatus of claim 12, wherein the analyzing of said at least one account holder category of information includes examining at least one characteristic of a BIN (bank identification number) included in an account number that points to a payment account to which the transaction is to be charged.

14. The apparatus of claim 13, wherein the analyzing of said at least one account holder category of information includes examining two characteristics of a BIN (bank identification number) included in an account number that points to a payment account to which the transaction is to be charged.

15. The apparatus of claim 12, wherein the analyzing of said at least one account holder category of information includes examining an age of a payment account to which the transaction is to be charged.

16. The apparatus of claim 12, wherein the transaction is with a merchant located in a first country and is to be charged to a payment account issued in a second country different from the first country.

17. A non-transitory storage medium storing program instructions, the program instructions for programming a processor to perform functions as follows:
receiving transaction data concerning a transaction; the transaction data including at least one account holder category of information associated with the transaction; the transaction data including at least one category of related transaction information associated with the transaction; the transaction data including at least one category of merchant-related information associated with the transaction; and
evaluating risk related to the transaction by analyzing information from (a) said at least one account holder category of information; (b) said at least one category of related transaction information; and (c) said at least one category of merchant-related information.

18. The storage medium of claim 17, wherein the analyzing of said at least one account holder category of information includes examining at least one characteristic of a BIN (bank identification number) included in an account number that points to a payment account to which the transaction is to be charged.

19. The storage medium of claim 18, wherein the analyzing of said at least one account holder category of information includes examining two characteristics of a BIN (bank identification number) included in an account number that points to a payment account to which the transaction is to be charged.

20. The storage medium of claim 17, wherein the analyzing of said at least one account holder category of information includes examining an age of a payment account to which the transaction is to be charged.

21. The storage medium of claim 17, wherein the transaction is with a merchant located in a first country and is to be charged to a payment account issued in a second country different from the first country.
